(19) United States
(12) Patent Application Publication
(10) Pub. No.: US 2010/0025941 A1
(43) Pub. Date: Feb. 4, 2010

(54) LEAD THROUGH DEVICE CABLES OR PIPES

(76) Inventor: Hans Hedström, Rattvik (SE)

Correspondence Address: HARNESS, DICKEY & PIERCE, P.L.C., P.O. BOX 8910, RESTON, VA, 20195, US

(21) Appl. No.: 12/448,788

(22) PCT Filed: Jan. 24, 2008
(86) PCT No.: PCT/SE2008/050083

§ 371 Date: Oct. 13, 2009

(30) Foreign Application Priority Data
Jan. 25, 2007 (SE) 0700184-5

(51) Int. Cl. F16L 5/08

(52) U.S. Cl. 277/606

(57) ABSTRACT

The invention concerns a lead through device for cables or pipes and comprises an outer sealing frame (2), in which at least one sealing module (3) is arranged surrounding a cable or a pipe (4), and which at least one sealing module (3) is designed to fill out the opening of the sealing frame (2) together with at least one compression unit (5). The sealing between wall (1), gasket (9) and sealing frame (2) is achieved in that an expansion unit, comprising an expander (6) of elastic material, pressure plates (7) and screws (8), which at tightening compress the expander (6) between the pressure plates and the sealing frame (2), expands the expander (6) towards the inside of the wall (1) and presses the frame (2) against the gasket (9) on the outer side of the wall (1).

The present invention refers to a lead through device for cables or pipes and comprises an outer sealing frame, in which at least one sealing module is arranged surrounding a cable or a pipe, and which at least one sealing module is designed to fill out the opening of the frame together with at least one compression unit. By means of the compression unit the sealing module, and possible additional one or more adjacent sealing modules, may be pressed against the frame and each other in such a way that a sealing is achieved.

According to prior art it is known to fix a sealing frame over an existing opening, when cables are to be inserted in e.g. a switch cabinet or through a wall. For the fixation of the frame through screws and gasket, double-stick gasket or welding are normally used. The cables or pipes are then pushed through the frame. Around each cable or pipe a sealing module is fastened. These sealing modules fill out the opening of the frame together with said compression unit, which in turn presses the sealing modules against each other and the frame, to obtain sealing.

One problem in fixing of the sealing frame by means of through screws and gasket is the risk of leakage along the screws. Due to the screws a wide gasket has to be used, which will give a worse sealing due to lower surface pressure. The making of holes in the wall for the screws demands certain accuracy, gives costs and is not suitable for fieldwork. Thus, it is desirable to avoid through screws for fixation of the frame. The technique of only using gaskets with adhesives adhering to fame and wall may lead to leakage if the surface is not completely dry and even, as the gasket is not put under pressure and forces from through cables or pipes may lead to that the frame come loose. The technique with welding is costly and time-consuming.

The object of the present invention is to solve these problems at a cable lead through device of the kind described above and the characterizing features of the invention are stated in the enclosed claims.

Thanks to the invention a cable lead through device is now achieved, which in an excellent way serves its purpose, at the same time as it is inexpensive and easy to manufacture and install. With a lead through device according to the invention a completely tight connection can be achieved between wall and sealing frame, in that an expansion unit is fixed to the sealing frame, which expands towards the inside of the wall and thereby presses the sealing frame against the outer side of the wall and against a gasket present between the wall and the sealing frame.

The invention will be described further below by means. of a preferred embodiment with reference to the enclosed schematic drawing, in which

FIG. 1 shows a lead through means for cables or pipes mounted across an opening in a wall,

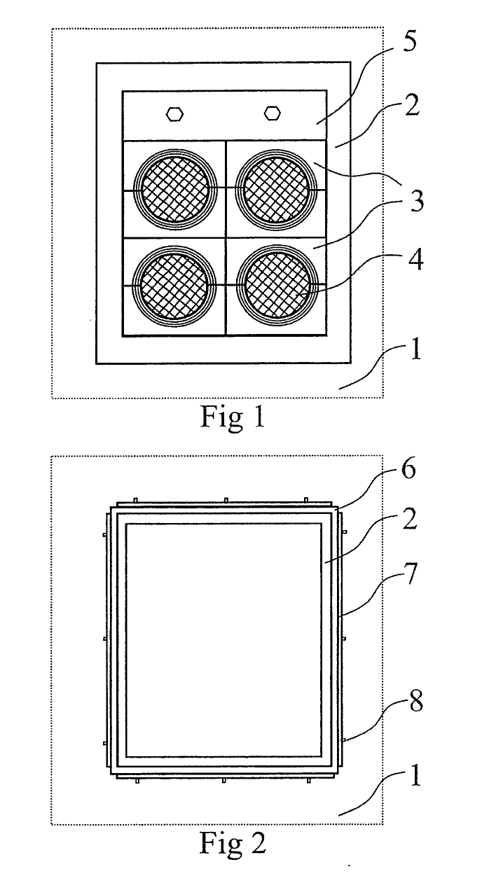

FIG. 2 shows from the inside of the wall a sealing frame with mounted expansion unit,

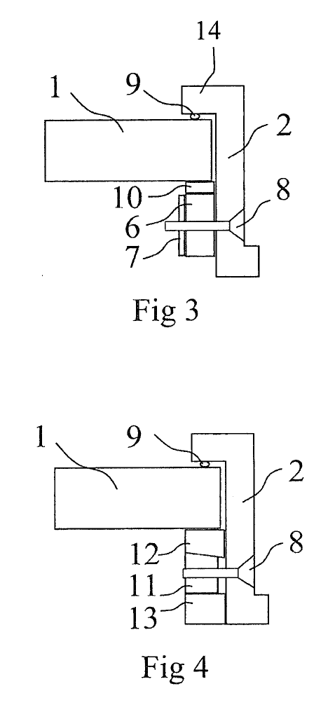

FIG. 3 shows an enlarged cross section of the sealing frame and its fixation in the wall,

FIG. 4 shows an enlarged cross section of the sealing frame having a modified design of the expansion unit.

As shown in FIG. 1 the invention according to its preferred embodiment comprises a cable lead through device, comprising a sealing frame 2, in which four sealing modules 3 for cables or pipes are arranged, which modules may be compressed by means of a compression unit 5 present in the sealing frame 2. The sealing frame covers an opening in the wall 1. The sealing frame 2 has a flange 14, see FIG. 3, which flange 14 projects over the wall 1. The flange 14 surrounds the opening of the wall 1 when the sealing frame 2 is mounted.

In FIG. 2 the sealing frame 2 with expander 6 and pressure plates 7 is shown from the inside of the wall together with visible parts of the screws 8.

In FIG. 3 the sealing frame 2, the wall 1 and a gasket 9 are shown. The gasket 9 is placed between the wall 1 and the flange 14 of the sealing frame 2. A screw 8 goes through the sealing frame 2, an elastic expander 6 and a pressure plate 7 at an outer side of the elastic expander 6. A spacer frame 10 is placed between the elastic expander 6 and the wall 1. The screw 8 is threaded in the pressure plate 7 and compresses the elastic expander 6 placed between the sealing frame 2 and the pressure plate 7. By the compression the elastic expander 6 will be compressed in the axial direction of the screw 8 and expand in other directions. By said expansion, the elastic expander 6 pressures against the spacer frame 10 on the inside of the wall 1 and the sealing frame 2 will be urged downwards as shown in FIG. 3. Hereby the sealing frame 2 is pressed against the gasket 9 on the outside of the wall in such a way that a completely satisfying sealing is achieved between sealing frame 2 and wall 1. The screw 8 is placed inside the sealing module 3 or the compression unit 5 and is sealed by them.

In FIG. 4 an expander 11 is shown, which is made of an inelastic material and having a chamfered side. The chamfered side of the expander 11 presses against a corresponding chamfered side of a spacer frame 12. A screw 8 goes through the sealing frame 2 and the expander 11. In starting position the expander 11 is placed at a distance from the sealing frame 2. When the screw 8 is tightened the expander 11 will be moved towards the sealing frame 2. By means of the co-operating chamfered surfaces of the expander 11 and the spacer frame 12 the spacer frame 12 will be pressed against the wall 1 when the screw 8 is tightened. In that the spacer frame 12 is pressed against the wall 1 the flange of the sealing frame 2 will be pressed against the wall 1. In the same way as shown in FIG. 3 a gasket 9 is placed between the flange of the sealing frame 2 and the wall 1. For a more robust design a support frame 13 may be mounted in the sealing frame 2.

As shown in FIGS. 3 and 4 the expander 6, 11 is placed on one or a first side of the wall 1, while the flange 14 of the sealing frame 2 is placed on the other or second side of the frame.

A number of embodiments may of course occur within the frame of the invention. For example the expander 6, 11 may be a unit surrounding the entire opening or be divided into smaller units. The pressure plate 7 can be divided into smaller units and to different extent partly surround the elastic expander 6 in order to control its expansion. The spacer frame 10 can vary in numbers or in thickness to compensate for different wall thicknesses.

1. A lead through device for cables or pipes comprising a sealing frame, in which at least one sealing module is arranged surrounding a cable or a pipe, and which at least one sealing module is designed to fill out the opening of the sealing frame together with at least one compression unit, by means of which the sealing module and possible one or more other adjacent sealing modules may be compressed, in such a way that sealing is achieved, wherein the sealing frame is received in an opening of the wall, wherein in that an expansion unit is fixed in the sealing frame, which expansion unit apply pressure against a first side of the wall and thereby presses the sealing frame against a gasket placed between a flange of the sealing frame and a second side of the wall.

2. The device of claim 1, wherein in that the expansion unit comprises an expander of elastic material, one or more pressure plates and screws for compressing the expander.

3. The device of claim 1, wherein in that the one or more pressure plates partly surrounds the expander.

4. The device of claim 1, wherein in that the expansion unit comprises an expander of inelastic material having a chamfered side, which presses against a corresponding chamfered side on a spacer frame.

5. The device of claim 4, wherein in that a support frame is mounted in the sealing frame, which support frame is placed abutting the expander on the side of the expander opposite the chamfered side of the expander.
